(19) United States
(12) Patent Application Publication
(10) Pub. No.: US 2003/0106445 A1
(43) Pub. Date: Jun. 12, 2003

(54) Driving member for rotating component intergral with a printing machine and method for separating said driving member

(76) Inventor: Anton Weis, Lorsch (DE)

Correspondence Address: Douglas R Hanscom, Jones Tullar & Cooper, P O Box 2266 Eads Station, Arlington, VA, 22202, US

(21) Appl. No.: 10/275,265

(22) PCT Filed: May 15, 2001
(86) PCT No.: PCT/DE01/01833

(30) Foreign Application Priority Data
May 17, 2000 (DE) 100-24-3327.4

(51) Int. Cl. B41F 13/008

(52) U.S. Cl. 101/216

(57) ABSTRACT

A rotating component of a printing machine is driven by a motor. A journal of the rotating components is connected to the shaft of the motor by at least a first coupling. The motor is supported for movement toward and away from the rotating component. The rotating component journal and the motor shaft are connected by the coupling in a manner that allows for the absorption of tensile and pressure stress. A second coupling allows angular movement of the motor shaft and the journal.

The invention relates to a drive mechanism for a rotating component of a printing press, and a method for disconnecting a drive mechanism from the rotating component in accordance with the preambles of claims 1, 8, 13 or 14.

A drive mechanism for a rotating component is known from DE 195 39 984 C2, wherein a motor is flanged to a lateral frame of a rotary printing press. This motor is connected by means of a disengagable coupling with a driveshaft driving several cylinders by means of a gear wheel chain.

DE 198 03 557 C2 discloses a drive mechanism for a rotating component of a printing press having a motor which can be moved axially in respect to the rotating component for the purpose of coupling and decoupling the rotating component.

An arrangement for an electric motor for driving a rotating body is known from EP 0 722 831 B1, wherein for the purpose of adjusting a side register, the rotor, which is directly connected with the rotating body, can be linearly displaced in relation to the stator and, if more lateral displacement is required, the stator itself can also be caused to track.

WO 98/51497 A2 discloses a drive mechanism for a rotating belt in the form of a position- or rpm-controlled motor, wherein the torque is transmitted via a universal joint and torsion-proof couplings from the motor to the rotating component and compensates angular deviations.

In connection with a drive mechanism for a rotating belt of a printing press, it is known from DE 44 36 628 C1 to provide a coupling which compensates angular deviations and transmits axial forces.

DE-OS 17 61 199 discloses a method and a device for exchanging a forme cylinder, wherein a coupling, which acts on a journal on the driven side of the cylinder, is released by remote control and the coupling is pulled off the journal by means of a precision-type brake motor, wherein the precision-type brake motor is also used for controlling the side register.

The object of the invention is based on creating a drive mechanism for a rotating component of a printing press and a method for disconnecting a drive mechanism.

In accordance with the invention, this object is attained by means of the characteristics of claims 1, 8, 13 or 14.

The advantages which can be attained by means of the invention reside in particular in that the drive mechanism for a rotating component accomplishes several tasks. For one, a disconnection of the drive mechanism from the rotating component can take place, for example for the purpose of a relative turning in respect to each other, or for decoupling. Secondly, a complete separation of the motor from the rotating component, i.e. the release of a mutual penetration, is possible, such as is required for example in a printing press, in particular a rotogravure printing press, for exchanging a forme cylinder. This is made possible in an advantageous manner by the interplay of a releasable coupling and the linearly displaceable drive mechanism together with a second coupling which can be exposed to a pressure load and a tensile load, as a rule a non-releasable one. Thirdly, by means of the drive mechanism it is possible, for example during the printing process, to displace the rotating component in its axial direction, for example a forme cylinder of a rotogravure printing press, for correction purposes, in particular for adjusting its side register.

In an advantageous manner driving of the rotating component takes place directly, and therefore without the working of the toothed wheel of a gear. A link joint assigned to the drive mechanism assures a wear-resistant driving operation, even if the motor has not been aligned exactly with the rotating component. The demands made on a solid relative rotary position between the motor, or a pulse transducer, and the rotating component are assured by means of a torsion-proof embodiment of the link joint and the arrangement of a pulse transducer on the motor shaft in the vicinity of the rotating component. An embodiment of the link joint in a manner in which tension and pressure forces can be absorbed in the axial direction of the rotating component is advantageous. It is furthermore advantageous that the relative movement mentioned can be performed in an electronically controllable manner, at least without a tool, and without having to remove the motor or the drive mechanism from the printing press. It is also advantageous that the process of coupling and decoupling can also be performed by remote control, wherein the supply of a pressure medium for the switching process takes place through the motor, in particular along the rotor shaft of the motor, and the drive mechanism.

An exemplary embodiment of the invention is represented in the drawings and will be described in greater detail in what follows.

Shown are in:

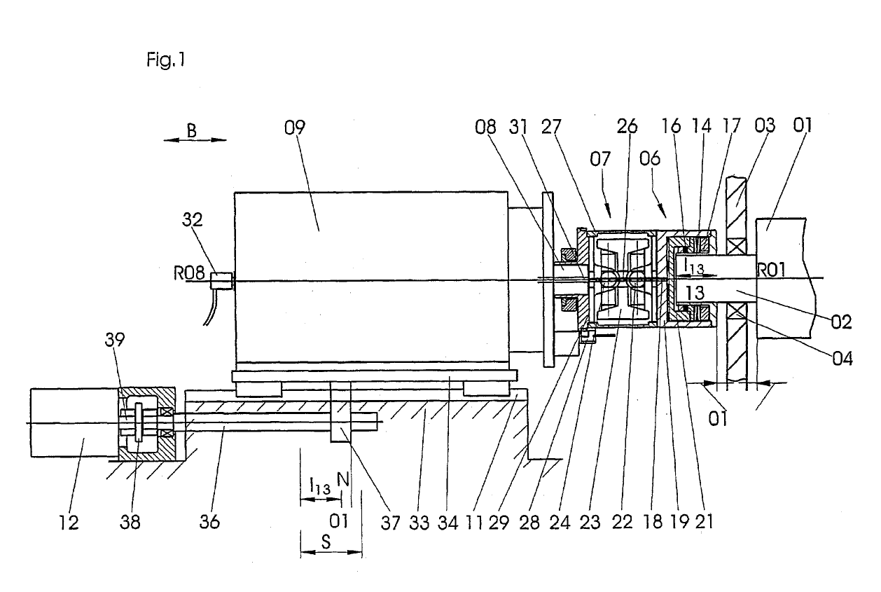

FIG. 1, a schematic representation of a drive mechanism for a rotating component of a printing press.

A rotating component 01, for example a cylinder 01 or a roller 01 of a rotary printing press, in particular a forme cylinder 01 of a printing press for rotogravure printing, has a journal 02 on its front end, by means of which the cylinder 01 is seated in a lateral frame 03 of a printing press in a bearing 04. The bearing 04 can be a rolling bearing, for example. If the cylinder 01 is intended to be displaceable in its radial direction, the bearing 04 can also represent an eccentric bearing 04. In a possible embodiment, the bearing 04 is designed in such a way that a relative movement between the lateral frame 03 and the journal 02 in the axial direction of the cylinder 01 is possible. For a simplified removal of the cylinder 01, the bearing 04 and/or the lateral frame 03 can be designed to be open toward one side of their circumferences, so that the cylinder 01 with its journal 02 can be removed, for example toward the top, from the lateral frame 03.

In the operational state the journal 02 of the cylinder 01 is connected by means of a first releasable coupling 06 and a second coupling 07, which compensates angular deviations, for example a link joint 07, with a shaft 08 of a motor 09. The motor 09 drives the cylinder 01 in a rotating manner during production and, if required, during the setup of the printing press. In a preferred embodiment the motor 09 is arranged coaxially in respect to an axis of rotation R01 of the rotating component 01. The shaft 08, or the axle 08 of the motor 09 can preferably be embodied as a rotor 08 of the motor 09. The motor 09 is arranged on a guide element 11 and can be linearly moved approximately parallel with the axial direction of the cylinder 01 by means of an actuating drive 12, for example a second motor 12.

In the operational state, the journal 02 extends on a partial element 13 of a length l13, for example l13=110 mm, into the front of the releasable coupling 06. The releasable coupling 06 which, in the operational state connects the journal 02 in a torsion-proof manner with the link joint 07, is embodied in an advantageous manner to be non-positive and, in the operational state, pretensioned, or self-locking and controllable.

In an advantageous embodiment, the coupling 06 is embodied in the form of tensioning elements 16, which are pretensioned by springs 14 on a cooperating tensioning bush 17. The coupling 08 is releasable in that a medium charged with pressure, for example a pressure medium such as oil in particular, is pressed via a conduit 18 in a housing 19 of the coupling 06 between the housing 19 and an axially displaceable piston 21. By means of this the springs 14 are compressed against their pretension and relieve the tensioning elements 16 acting together with the tensioning bush 17. Star disks 16, for example, can be used as tensioning elements 16. However, the coupling 09 can also be embodied as a controllable coupling in a different way, for example as a cone coupling, disk coupling, electromagnetic or fluid coupling.

On its side facing away from the cylinder 01, the coupling 06 is connected with the second coupling 07, in the example with a first joint 22 of the link joint 07. In a preferred embodiment the link joint 07 is embodied as a double joint 07, having the first joint 22, a shaft 23 and a second joint 24, which compensates possibly existing angles and/or an offset between an axis of rotation R08 of the shaft 08 of the motor 09 and an axis of rotation R01 of the cylinder 01. The latter in particular in case of a seating of the cylinder 01 whose position can be radially changed, for example for placement against or away from the matter to be printed. The joints 22 and 24 can be embodied for example as universal joints, as ball-and-socket joints, or in any other form, as a positive connection with changeable angles, which absorb tension and pressure forces in approximate spatial directions along the axes of rotation R01 and R08, and have the above-mentioned compensating properties in relation to angle and offset. In an advantageous manner the line 26, which conveys he pressure medium and is connected with the conduit 18, for example a hose 26, is passed through the double joint 07. In the example the line 26 was passed centrally through the shaft 23.

The second joint 24 is connected, on the front face and centered in relation to the axis of rotation R08, with the shaft of the motor 09. In an advantageous manner, the arrangement of the coupling 06 and link joint 07 is encapsulated by a cover 27 extending from the shaft 08 to the journal 02.

In one embodiment, the shaft 08 of the motor 09 has a pulse transducer 28 on its rotating jacket surface, which acts together with a sensor, not represented, and whose angular position provides information at any time regarding the rotational position and/or speed of rotation of the cylinder 01. In a preferred embodiment the pulse transducer 28 is arranged on the circumference of the rotating first coupling 06, or the second coupling 07 itself, in the example on the circumference of a front face 29 of the coupling 07 receiving the second joint 22 and acting together with the shaft 08. By means of this a synchronous movement between the rotating component 01 and the pulse transducer 28 via the torsion-proof coupling 07 is assured.

The shaft 08 has a preferably centrally arranged bore 31, through which the pressure medium reaches the coupling 06 via the line 26. Therefore the supply of pressure medium for actuating the coupling 06 can be accomplished in a simple manner, for example via a rotary lead-in 32 through the shaft 08 of the motor 09 and via the line 26 to the conduit 18 of the coupling 06. Seating of the shaft 08 in the motor 09 is advantageously provided by a radial bearing, not represented, which also absorbs a force component in an axial direction, which is approximately parallel in respect to the axis of rotation R08, for example by means of an inclined bearing, so that an axial relative movement between the shaft 08 and the motor 09 is prevented. The position of the stator seated on the guide element 11 and the rotor, or the shaft 08, cannot be axially changed in relation to each other. The motor 09 preferably is an electric motor 09 controlled via its angle of rotation, or positionally controlled.

The motor 09 is arranged approximately parallel in relation to the axis of rotation R08 by means of the guide element 11, for example on a support 33, and is linearly movable in a movement direction B. In a preferred embodiment the support 33 is fixed in place in respect to the lateral frame 03, and the guide element 11 is embodied as a linear guide 11. The guide element 11 between the motor 09 and the support 33 can be designed as a flat or dove-tailed guide element, wherein a movement as smooth-running as possible in the forward direction, and seating as free of play as possible in all remaining directions, must be assured. For this purpose feet 34 arranged on the motor 09 and acting together with the guide element 11, or the guide element 11 itself, have rotary bearings, not represented here.

In the example, the motor 09 can be linearly displaced in the direction of movement B by means of the second motor 12 via a threaded drive mechanism 36, for example a threaded spindle 36 with a trapezoidal thread. The threaded spindle 36 is in engagement with an interior thread arranged in the motor 09, which is fixed in place in respect to the motor 09. The interior thread can be a part of a nut 37 fastened on the motor 09. To minimize possibly occurring thread play between the threaded spindle 36 and the nut 37, a second, adjustable nut can be arranged, for example, or other steps can be taken.

The threaded spindle 36 is rotatably arranged, but is fixed in place in respect to the support 33 and, in an advantageous embodiment, is directly driven via a second coupling 38 between a shaft 39 of the motor 12 and the threaded spindle 36, for example a universal joint coupling, which compensates angular deviations. The rotary position of the motor 12 is also controlled in a preferred embodiment, which makes possible the exact positioning of the motor 09 in the direction of movement B. However, positioning can also be provided via path-detecting sensors at the threaded spindle 36. The driving of the threaded spindle 36 can also be performed via a drive mechanism, in which case appropriate precautions regarding possible thread play must be taken.

In an advantageous embodiment the entire regulating distance S, starting at a zero position N, in the direction facing away from the cylinder 01 has at least the length l13 of the portion of the journal 02 projecting into the coupling 06. In order to make possible a correction of the cylinder 01, or an adjustment of the side registration, in the axial direction by a regulating distance d01, for example by d01=±10 mm, a regulating distance d01 in respect to the zero position N of at least 10 mm in both directions is required, wherein a distance a03 between the lateral frame 03 and the coupling 06, as well as a distance a01 between the cylinder 01 and the lateral frame 03, must be of corresponding size.

The manner of functioning or the drive mechanism in accordance with the invention for a rotating component 01 of a printing press is as follows:

A correction of the axial position of the cylinder 01, for example by the regulating distance d01 in the direction toward the lateral frame 03, takes place by actuating the motor 12, for example over an appropriately standardized angle of rotation, and the rotating threaded spindle 36. The motor 09 is linearly displaced in the direction of movement B in relation to the lateral frame 03, and in turn moves the cylinder 01 via the link joint 07, which can be charged with tension and pressure, in the direction toward the lateral frame 03. In the course of this correction, the coupling 06 is engaged, and also represents a connection which can be charged with tension and pressure.

However, if the cylinder 01 and the drive mechanism are to be uncoupled, or even separated from each other, first the release of the coupling 06 takes place by means of charging the coupling 06 with the pressure medium. Now the cylinder 01 can be freely turned around its axis of rotation R01, or its position can be changed linearly along the axis of rotation R01 in relation to the coupling 06. In order to completely separate the coupling 06 and the journal 02 spatially from each other, the motor 09 with the link joint 07 and the coupling 06 is first linearly displaced at least by the length l13 by means of the motor 12 and the threaded spindle 36. Now it is no longer necessary to charge the coupling 06 with pressure, the coupling 06 can be relieved of the pressure medium and the cylinder 01 can be removed, or replaced.

### List of Reference Symbols

01 Rotating component, cylinder, roller, forme cylinder

02 Journal

03 Lateral frame

04 Bearing, eccentric bearing

05 -

06 Coupling, first, releasable

07 Coupling, second, link joint, double joint

08 Shaft, axle, rotor (09)

09 Motor, electric motor

10 -

11 Guide element, linear guide

12 Actuating drive, motor

13 Partial element (02)

14 Spring

15 -

16 Tensioning element, star disks

17 Tensioning bush

18 Conduit

19 Housing

20 -

21 Piston

22 Joint, first

23 Shaft

24 Joint, second

25 -

26 Line,hose

27 Cover

28 Pulse transducer

29 Front side (07)

30 -

31 Bore

32 Rotary lead-in

33 Support

34 Foot

35 -

36 Threaded drive mechanism, threaded spindle

37 Nut

38 Coupling

39 Shaft

B Direction of movement

N Zero position

S Regulating distance (29)

R01 Axis of rotation (01)

R08 Axis of rotation (08)

a01 Distance (01, 03), regulating distance (01)

a03 Distance (01, 06)

d01 Regulating distance (01)

113 Length (13)

1. A drive mechanism for a rotating component (01) of a printing press, wherein the component (01) can be rotatingly driven by a motor (09), and the rotating component (01) is connected at its front face with the motor (09) driving the rotating component (01) via a first coupling (06), and wherein the position of the motor (09) can be changed in a direction with at least one component parallel in respect to the axis of rotation (R01) of the rotating component (01), characterized in that the position of the motor (09) can be changed by means of an actuating drive (12).

2. The drive mechanism in accordance with claim 1, characterized in that the position of the motor (09) can be selectively changed by means of the actuating drive (12) either together with the rotating component (01) or without the rotating component (01).

3. The drive mechanism in accordance with claim 1, characterized in that the first coupling (06) is embodied to be releasable and, in the coupled-in state, to be chargeable by pressure and tension in the axial direction of the rotating component (01).

4. The drive mechanism in accordance with claim 1, characterized in that a journal (02) arranged at the front face of the rotating component (01) and a shaft (08) of the motor (09) are connected with each other in a manner in which they can be charged by tension or pressure in respect to a movement with at least one component parallel with the axis of rotation (R01) of the rotating component (01) by means of a second coupling (07) which compensates angular deviations.

5. The drive mechanism in accordance with claim 1, characterized in that a regulating distance (S) of the actuating drive (12) is greater than a length (l13) of a partial element (13), which is in engagement with the coupling (06), of a journal (02) on the front side of the rotating component (01).

6. The drive mechanism in accordance with claim 4, characterized in that the second coupling (07) is embodied as a link joint (07, 22, 23, 24).

7. The drive mechanism in accordance with claim 6, characterized in that the second coupling (07) is embodied as a double joint (07).

8. A drive mechanism for a rotating component (01) of a printing press, wherein the component (01) can be rotatingly driven by a motor (09), and the rotating component (01) is connected at its front face with a shaft (08) of the motor (09) driving the rotating component (01) via a coupling (06), which can be controlled by means of a pressure medium, characterized in that the pressure medium can be supplied to the coupling (06) through the shaft (08) of the motor (9).

9. The drive mechanism in accordance with claim 8, characterized in that the position of the motor (09) can be changed in a direction with at least one component parallel in respect to the axis of rotation (R01) of the rotating component (01).

10. The drive mechanism in accordance with claims 1 or 8, characterized in that the motor (09) is arranged on a guide element (11).

11. The drive mechanism in accordance with claims 1 or 9, characterized in that the actuating drive (12) is embodied as a second motor (12).

12. The drive mechanism in accordance with claims 1 or 8, characterized in that the rotating component (01) can be releasably and non-positively connected with the shaft (08) of the motor (09) via the first coupling.

13. A drive mechanism for a rotating component (01) of a printing press, wherein the component (01) can be rotatingly driven by a motor (09), and the rotating component (01) is connected at its front face with the motor (09) driving the rotating component (01) via at least one coupling (06), and wherein the number of revolutions and/or the angle of rotation position of the motor (09) can be controlled by means of a pulse transducer providing information regarding the speed of rotation and/or the angle of rotation position, characterized in that the pulse transducer (28) is arranged on the circumference of the coupling (06, 07).

14. A method for separating a drive mechanism from a rotating component (01) of a printing press, wherein the rotating component (01) is driven in a rotating manner by a motor (09) and in the coupled state the rotating component (01) is connected at its front with a shaft (08) of the motor (09) driving the rotating component (01) via a coupling (06), characterized in that first the coupling (06), which can be charged with tension and pressure in the axial direction in the engaged state, is released by remote control, and thereafter, for separating the drive mechanism disengaged from the rotating component (01), the motor (09) is linearly moved by means of an actuating drive (12) in a direction with at least one component parallel with the axis of rotation (R01) of the rotating component (01).

15. The method in accordance with claim 14, characterized in that the motor (09) is moved on a guide element (11) over a regulating distance (S) which is greater than a length (l13) of a partial element (13) of a journal (02) which is in engagement with the coupling (06).

16. The method in accordance with claim 14, characterized in that the coupling (06) is released by being charged with a pressure medium.
